(19) United States
(12) Patent Application Publication
(10) Pub. No.: US 2010/0160090 A1
(43) Pub. Date: Jun. 24, 2010

(54) METHOD AND SYSTEM FOR DETERMINING POSITIONAL INFORMATION ON A GOLF COURSE

(76) Inventors: Tzu-Wei Lin, Taipei City (TW); Meng-Hsiang Chang, Taipei City (TW); Chien-Lung Chen, Taipei City (TW); Chi-Wen Chen, Taiwan City (TW)

Correspondence Address: GENE I. SU, 17F-1, No. 151, SEC. 4, XINYI ROAD, TAIPEI, TW

(21) Appl. No.: 12/339,484

(22) Filed: Dec. 19, 2008

(51) Int. Cl. A63B 57/00; G06F 19/00

(52) U.S. Cl. 473/407; 473/409; 700/91

(57) ABSTRACT

One embodiment of the invention sets forth a method, which includes receiving a first position on the golf course, searching for a first predetermined code representative of a first region on the golf course on a first image, and determining a first minimum distance and a first maximum distance between the first position and the first region after having identified the first predetermined code.

### BACKGROUND OF THE INVENTION

### DESCRIPTION OF THE RELATED ART

Unless otherwise indicated herein, the approaches described in this section are not prior art to the claims in this application and are not admitted to be prior art by inclusion in this section.

As the popularity of golf continues to grow, an increasing number of accessory products associated with golf have also been commercialized. Various types of portable devices specifically designed to assist golfers are currently available. The conventional portable devices are capable of approximating and displaying certain distance information. The portable devices generally need to be within a pre-defined region on a golf course to trigger the distance calculation. In the event that a golfer accidentally or purposely misses the pre-defined region, the distance information is not calculated. In addition, each of the pre-defined regions is typically associated with one or more pre-defined points on the golf course. When the golfer is in the pre-defined region, the triggered distance calculation is based on the location of the pre-defined point, not the actual location of the golfer. Sometimes, the location of the pre-defined point is far away from the actual location. Thus, such a crude approximation of the distance from the location of the golfer to a destined location is often not helpful for a golfer to plan his or her next shot.

What is needed in the art is thus a method and system for determining positional information on a golf course and addresses at least the problems discussed above.

### SUMMARY OF THE INVENTION

An apparatus and method for determining positional information on a golf course is disclosed. One embodiment of the invention sets forth a method, which includes receiving a first position on the golf course, searching for a first predetermined code representative of a first region on the golf course on a first image, and determining a first minimum distance and a first maximum distance between the first position and the first region after having identified the first predetermined code.

At least one advantage of the invention is to accurately and comprehensively determine distance information to the various regions on a golf course from a position of a personal golf game assistant.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the drawings. It is to be noted, however, that the drawings illustrate only typical embodiments of this invention and are therefore not to be considered limiting of its scope, for the invention may admit to other equally effective embodiments.

FIG. 1 is a simplified block diagram illustrating a personal golf game assistant capable of providing distance information according to one embodiment of the invention;

FIG. 2A is an example of a rectified satellite image FIG. 2A is an example of a rectified satellite image 200 of a golf hole of a golf hole;

FIG. 2B is an example of a virtual image derived from the rectified satellite image in FIG. 2A;

FIG. 2C is a table of terrain codes used to encode contours on a virtual image according to one embodiment of the invention;

FIG. 2D illustrates an encoded image portion according to one embodiment of the invention;

FIG. 3 is a flow chart showing a process for determining distance information according to one embodiment of the invention;

FIG. 4A is a schematic diagram illustrating a search for the presence of the terrain codes on an encoded image, according to one embodiment of the invention; and

FIG. 4B is an example showing a result of a search according to one embodiment of the invention.

### DETAILED DESCRIPTION

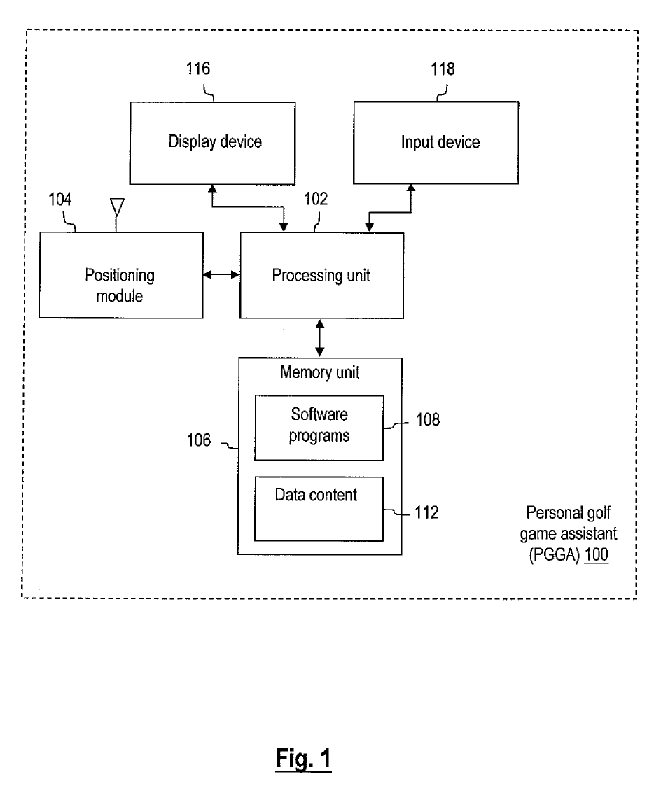

FIG. 1 is a simplified block diagram illustrating a personal golf game assistant (PGGA) 100 capable of providing distance information according to one embodiment of the invention. The PGGA 100 includes a processing unit 102, a positioning module 104, a memory unit 106 containing software programs 108 and data content 112, a display device 116, and an input device 118. The processing unit 102 is configured to control the operations of the positioning module 104, execute one or more software programs 108, process the data content 112, send image data to the display device 116, and receive input signals from the input device 118. In one implementation, the positioning module 104 is a satellite-based global positioning system (GPS).

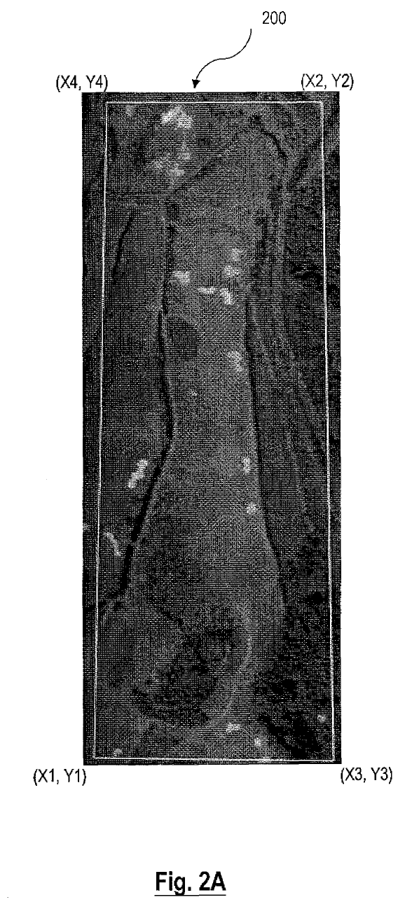

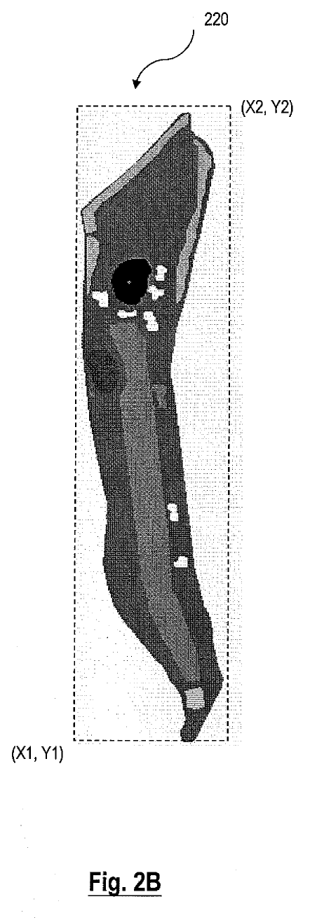

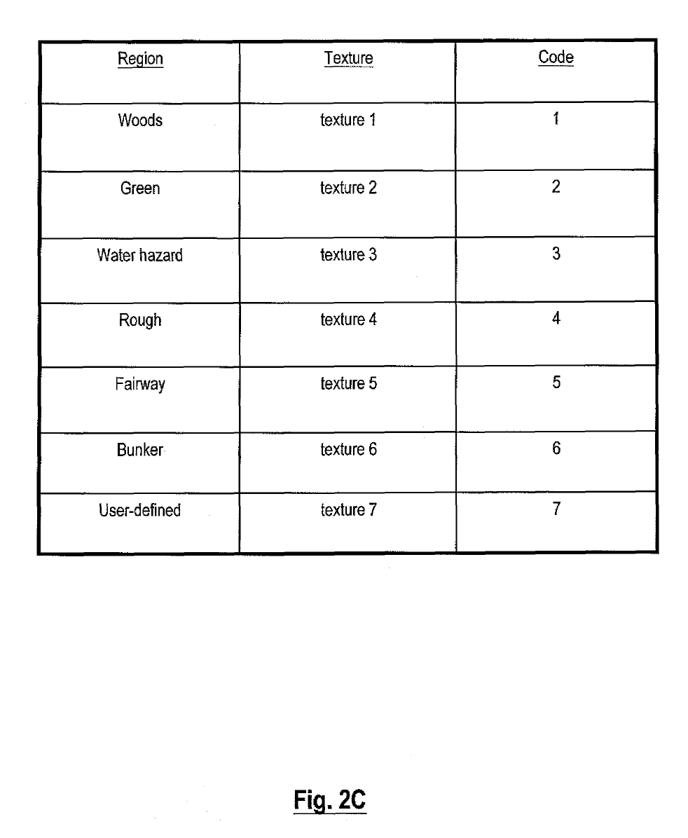

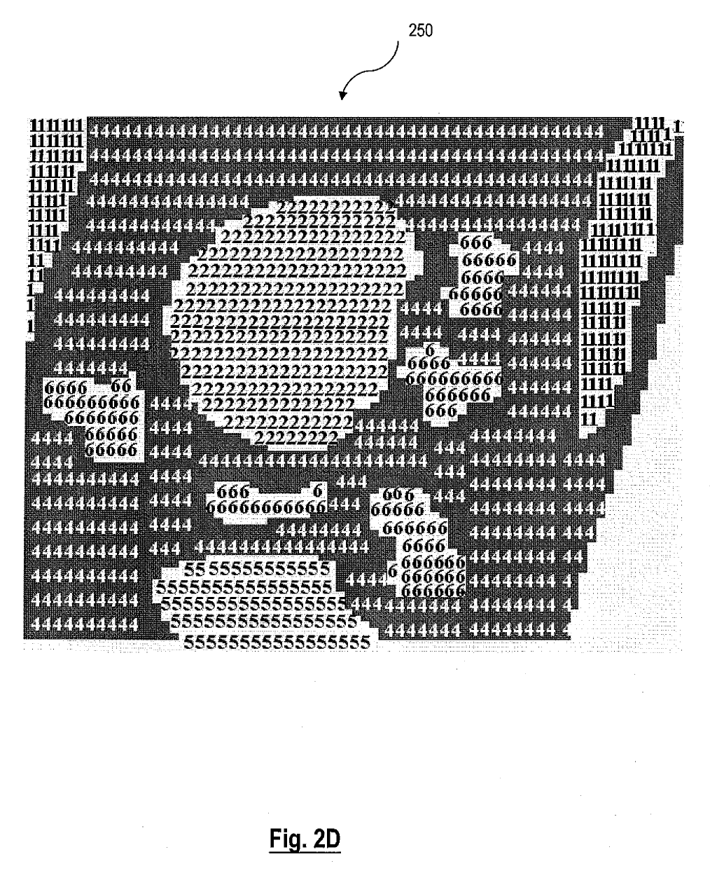

FIG. 2A is an example of a rectified satellite image 200 of a golf hole. The golf hole may include regions such as a putting-green, a tee box, a fairway, a rough area, a water-hazard, and/or a bunker. In one implementation, any satellite image 200 is rectified before being stored into the PGGA 100 of FIG. 1. The rectification may include, without limitation, rotating the satellite image 200 so that the putting-green of the golf hole is at the top of the golf hole, and the tee box is at the bottom of the same hole. The rectification may also include mathematically compensating for the effect of the skew associated with the retrieval of the satellite image 200. The skew may be introduced by factors such as the orbit of the satellite, the angle at which the satellite image 200 is captured, and others. The rectification may further include assigning latitude and longitude positional information such as (X1, Y1), (X2, Y2), (X3, Y3) and (X4, Y4) to the four corners of the satellite image 200 and limiting the size of the satellite image 200, so that the satellite image 200 is properly scaled.

FIG. 2B is an example of a virtual image 220 derived from the rectified satellite image 200 in FIG. 2A. The virtual image 220 includes contours, each of which corresponds to a region of the golf hole shown on the satellite image 200. The contours can be either drawn manually or by computer-aided software. The virtual image 220 is configured to be proportional to the satellite image 200, so that the contours on the virtual image 220 are also configured to be proportional to the regions shown on the satellite image 200. To ensure the proper mapping between the virtual image 220 and the satellite image 200, the lowermost left corner of the virtual image 220, (x1, y1), is set to correspond to the lower left corner of the satellite image 200, (X1, Y1). In one implementation, (x1, y1) of the virtual image 220 is set to be equal to (X1, Y1) of the satellite image 200.

FIG. 2C is a table of terrain codes used to encode contours on the virtual image 220 according to one embodiment of the invention. Each contour corresponds to a predetermined terrain code and can be represented by the terrain code. For example, each pixel of the contour corresponding to the “woods” is assigned with the terrain code of 1, and each pixel of the contour corresponding to the “green” is assigned with the terrain code of 2. In one implementation, a pixel broadly corresponds to an area with a certain length and width in the virtual image 220. Using this encoding approach, an encoded image is generated. In addition to terrain codes, the table may optionally include texture information, such as colors and physical properties, for the contours. Each encoded contour is associated with its corresponding texture information, so that the contour can be displayed with enhanced realism. Suppose the contour is the bunker. The bunker is displayed with the texture information that reflects the color and physical properties of sand.

FIG. 2D illustrates an encoded image portion 250 according to one embodiment of the invention. In one implementation, an encoded image is represented by an array of terrain codes. The size of the array may be predetermined and may correspond to the number of the pixels representing the virtual image 220. The encoded image portion 250 shows terrain codes of 1, 2, 4, 5, and 6. By referring back to the terrain code table shown in FIG. 2C, the encoded image portion 250 includes five different types of encoded contours. They are woods, green, water hazard, rough, fairway, and bunker. Another terrain code, a user-defined code, is not shown in the encoded image portion 250 but generally refers to a user-specified region. In one implementation, the PGGA 100 of FIG. 1 may receive an input signal via the input device 118, such as an input signal from pressing on a particular region on the virtual image 220 of FIG. 2B, and this input signal is converted to the user-defined code.

In one implementation, the lowermost left corner of an encoded image, of which the encoded image portion 250 is a part, is configured to correspond to the lowermost left corner of the virtual image 220. In one implementation, the coordinate of lowermost left corner of the encoded image may be set to be equal to the coordinate of the lowermost left corner of the virtual image 220. The terrain codes along with the coordinates of the lowermost left and uppermost right corners of each encoded image are in one implementation stored in the PGGA 100 of FIG. 1.

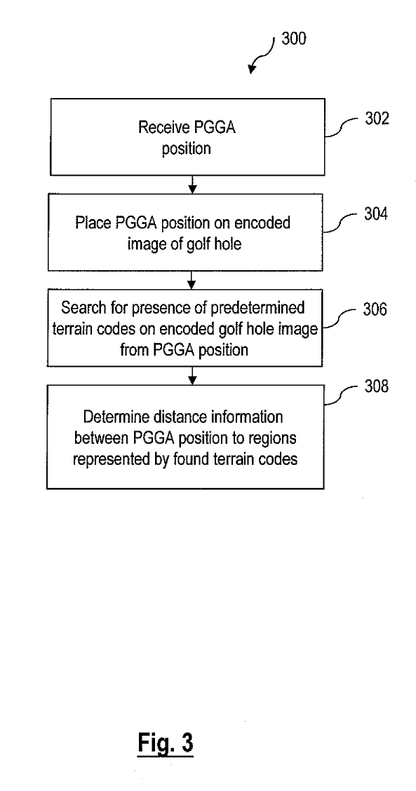

FIG. 3 is a flow chart showing a process 300 for determining distance information according to one embodiment of the invention. In one implementation, the PGGA 100 of FIG. 1 is configured to not only determine the distances to the various regions on a golf course but also provide the information about in which direction the regions locate. Upon receipt of a position of PGGA 100 in step 302, the processing unit 102 may superimpose the PGGA position on a virtual image to be displayed on the PGGA 100. This PGGA position may be acquired by the positioning module 104. In one implementation, the PGGA 100 ensures that the PGGA position is within the boundary of one of the stored virtual images that can be displayed. Suppose the boundary of a first stored virtual image is associated with (x1, y1) and (x2, y2), and (x1, y1) corresponds to the coordinates of the lower-left corner of the boundary, and (x2, y2) corresponds to the coordinates of the upper-right corner of the boundary. Suppose further that the PGGA position is (x3, y3). if the conditions of x1<x3<x2 and y1<y3<y2 are met, then the position can be superimposed on the first stored virtual image. On the other hand, if either of the conditions is not satisfied, then the PGGA 100 is configured to look for another stored virtual image to see whether the PGGA position falls within its boundary. It is worth noting that the virtual image or any other image to be displayed on the PGGA 100 may be stored in the PGGA 100 before shipment or may be downloaded from a website. In one implementation, the processing unit 102 patches appropriate stored texture information onto the pixels in the virtual image according to the mappings provided in the table shown in FIG. 2C. As a result, a more realistic image can be displayed on the display device 116. It is worth noting that in another implementation, the PGGA 100 may display the rectified satellite image. In yet another implementation, the PGGA 100 may display the virtual image without any texture information.

In step 304, the processing unit 102 places the position of the PGGA 100 on the encoded image of a golf hole. In one implementation, the coordinates of the PGGA 100 location is in the same coordinate system as the encoded image, so that no conversion from one coordinate system to another is needed. In addition, the position of the PGGA 100 can be utilized so long as the PGGA position is within the boundary of the encoded image. However, if the position of the PGGA 100 is outside the boundary of an encoded image, the PGGA 100 in one implementation can identify another encoded image covering the PGGA 100 position but indicate that the wrong hole is being played.

In step 306, the processing unit 102 searches for the presence of the terrain codes on the encoded image from the position of the PGGA 100. More specifically, the processing unit 102 searches for the pixels on the encoded image assigned with the predetermined terrain codes from the position of the PGGA 100. In one implementation, the search is conducted in multiple predetermined directions covering 360 degrees from the position of the PGGA 100. The search for each predetermined direction covers all the pixels along a line connecting the PGGA 100 position to the boundary of the encoded image. In one implementation, a predetermined angular increment is introduced between two successive predetermined directions. After finding the terrain codes, the processing unit 102 in step 308 determines certain distance information between the PGGA 100 position and also the regions represented by the found terrain codes.

Alternatively, the process 300 can be performed by a different computing device. To illustrate, suppose the PGGA is a simplified version of the PGGA 100 shown in FIG. 1, and much of the processing performed by the PGGA 100 as discussed above is instead handled by the computing device. After the simplified PGGA obtains certain information relating to a round of golf, such as the various positional information of the PGGA, the information is sent to the computing device. The computing device then performs the process 300 and can optionally send the results back to the simplified PGGA. The computing device can be any device with a processing unit and a memory unit.

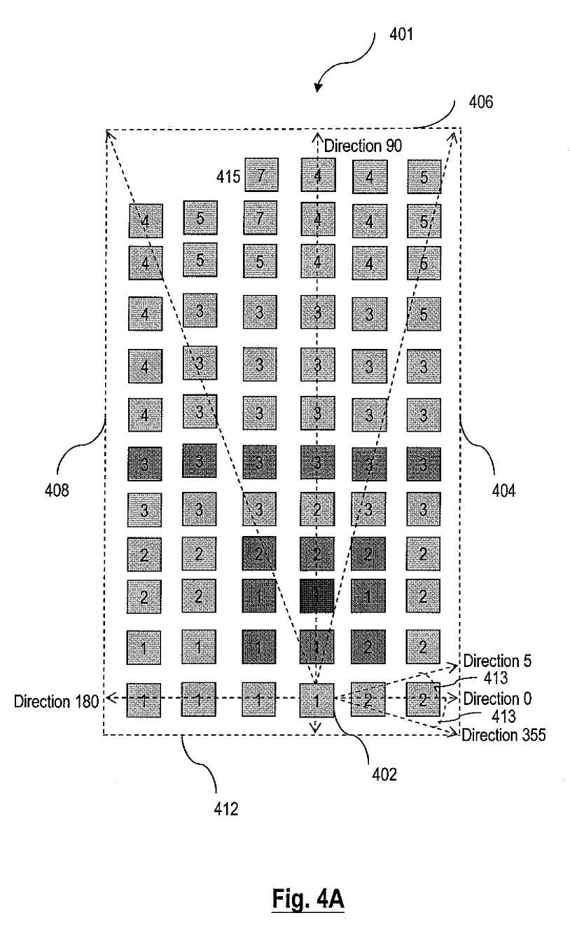

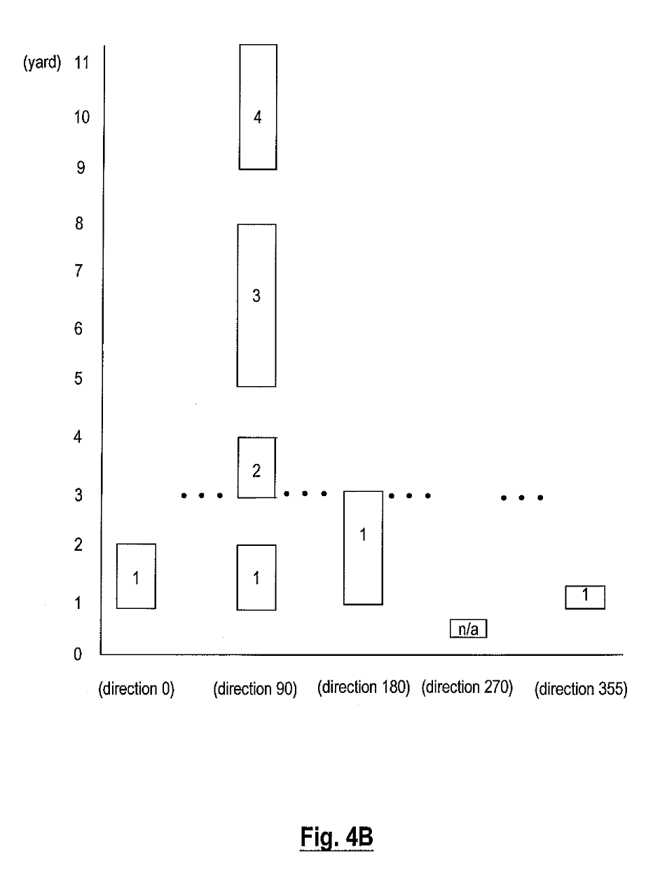

FIG. 4A is a schematic diagram illustrating a search for the presence of the terrain codes on the encoded image 401, according to one embodiment of the invention. The search for the presence of the terrain code is conducted along lines connecting the position of the PGGA 100 of FIG. 1 to boundaries 404, 406, 408, and 412 of the encoded image 401. In one implementation, the search is performed along a first line connecting the PGGA 100 position to the boundary 404, which is referred to as 0 degree and is denoted as “direction 0.” The search continues along another direction that is a predetermined angular increment 413 apart from the direction 0. In one implementation, the predetermined angular increment 413 is 5 degrees. Thus, the search for the terrain code is performed along a second line that is 5 degrees apart from direction 0 and is denoted as “direction 5”. The search is deemed to have completed after 360 degrees around the position of the PGGA 100 are covered. Here, once the search along a “direction 355” is performed, the search is considered to have completed. Assume the position of the PGGA 100 is at pixel 402 having the terrain code of 1. Two pixels of the terrain code 2 will be located in direction 0. Since each pixel in the encoded image is representative of a certain length and width depending on the size of the array of the pixels and the size of the golf hole, the distance from the position of the PGGA 100 to the region assigned with the terrain code 2 in the direction 0 can be determined. For example, suppose each pixel is equal to one yard long and one yard wide. The minimum distance and the maximum distance from the pixel 401 to the region assigned with the terrain code 2 are 1 yard and 2 yards, respectively.

In one implementation, the search for the terrain codes is conducted every time the PGGA 100 moves. In another implementation, the search is initiated by certain inputted signals received by the PGGA 100. The example in FIG. 4A also shows that three pixels with the terrain code of 1 are located in a direction that is 180 degrees apart from direction 0 (“direction 180”). Continuing with the example above, the minimum distance and the maximum distance to the region assigned with the terrain code of 1 in the direction 180 are one yard and three yards, respectively.

In should be apparent to a person having ordinary skills in the art to recognize that the accuracy of the searches improves as the pixel size and the angular increment is further refined. In other words, suppose each pixel goes from 1 yard long and 1 yard wide to 0.5 yard long and 0.5 yard wide, and the angular increment goes from 5 degrees to 2.5 degrees. The results obtained with the further refined pixel size and angular increment are likely to be more precise.

In an alternatively embodiment, the aforementioned search for the presence of terrain codes on an encoded image of a golf hole may be focused on a specified area. In one implementation, the specified area primarily refers to the area covered by a certain angular range, and the angular range depends on a line connecting the position of the PGGA 100 and a target position, such as the cup position of the golf hole or a user-defined position. For example, the angular range may refer to 30 degrees to the right and to the left of such a line. Then, unlike the 360-degree search described above, this focused search looks for the presence of terrain codes within a specified area covered by a 60-degree angular range relative to the line on an encoded image.

In one implementation, the cup position is stored along with the encoded image. In another implementation, the user-defined position is established through an input device, such as the input device 118, of FIG. 1. After the position of the PGGA 100 is superimposed on the encoded image, a line connecting the PGGA position and the cup position can be readily formulated. It is worth noting that the angular range depending on this line can be manually established or adjusted over the course of play.

FIG. 4B is an example showing a result of a search according to one embodiment of the invention. FIG. 4B shows the region assigned with the terrain code of 1 occupies 1-2 yards in the direction 0 from the position of the PGGA 100. FIG. 4B also shows that the regions assigned with the terrain codes 1, 2, 3, and 4 are 1-2, 3-4, and 5-8, and 9-11 yards away from the position of the PGGA 100, respectively, in a direction that is 90 degrees counterclockwise apart from direction 0 (“direction 90”). FIG. 4B also shows no presence of any region is detected in a direction that is 270 degrees counterclockwise apart from direction 0 (“direction 270”). Meanwhile, the region assigned with the terrain code 1 is one yard away from the position of the PGGA 100, respectively, in the direction 355. With the aforementioned distance information, the minimum distance and the maximum distance to the region from the PGGA 100 location can be efficiently determined.

In addition, the PGGA 100 is also configured to acquire the sequence information (e.g., terrain code 1 is identified before terrain code 2 in the direction 90). With the sequence information, the relative locations of the regions on the golf course can be determined. Using the direction 90 as an example, the region assigned with terrain code 1 is the closest on PGGA 100. Then, immediately next to the region assigned with terrain code 1 in the same direction is the region assigned with terrain code 2. Maintaining information of how the location of one region relates to another region on the golf course can be utilized to generate useful information such as a golf ball failing to be on the fairway and missing to the right of the fairway. In one implementation, the above mentioned distance information and the sequence information are stored in the PGGA 100.

It is worth noting that the PGGA 100 does not necessarily display FIG. 4B. Instead, the data shown in FIG. 4B may reflect the data that the PGGA 100 stores, retrieves, and utilizes to determine different positional information on a golf course.

The above description illustrates various embodiments of the invention along with examples of how aspects of the invention may be implemented. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, ROM chips, or any type of solid-state non-volatile semiconductor memory) on which information is permanently stored; and (ii) writable storage media (e.g., floppy disks within a diskette drive, CD-RW disks, DVD-RW disks, flash memory, hard-disk drive, or any type of random-access memory) on which alterable information is stored. The above examples, embodiments, instruction semantics, and drawings should not be deemed to be the only embodiments, and are presented to illustrate the flexibility and advantages of the invention as defined by the following claims.

We claim:

1. A method for determining positional information on a golf course having a plurality of regions, the method comprises:
receiving a first position on the golf course;
searching for a first predetermined code representative of a first region on the golf course on a first image; and
determining a first minimum distance and a first maximum distance between the first position and the first region after having identified the first predetermined code.

2. The method of claim 1, wherein the determining the first minimum distance and the first maximum distance is performed within an angular range based on the first position.

3. The method of claim 2, wherein the angular range is further dependent on a line connecting the first position and a target position on the golf course.

4. The method of claim 1, wherein the first region is encoded with the first predetermined code prior to the searching for the first predetermined code.

5. The method of claim 2, wherein the searching for the first predetermined code is performed along a first line connecting the first position and a boundary of the first image.

6. The method of claim 5, further comprising:
searching for a second predetermined code representative of a second region on the golf course along the first line; and
determining a second minimum distance and a second maximum distance between the first position and the second region after having identified the second predetermined code.

7. The method of claim 6, further comprising maintaining a record of a sequence of identifying the first predetermined code and the second predetermined code, the first minimum distance and the first maximum distance, and the second minimum distance and the second maximum distance.

8. The method of claim 7, further comprising analyzing play on the golf course based on the record.

9. The method of claim 8, wherein the analyzing play further comprising determining fairway in regulation (FIR), green in regulation (GIR), or positional information of a golf ball relative to the regions.

10. The method of claim 8, further comprising displaying results from the analyzing play.

11. The method of claim 10, wherein the results from the analyzing play are updated each time the first position changes.

12. The method of claim 5, wherein the searching for the first predetermined code is performed along a second line with a predetermined angular increment apart from the first line.

13. A device for determining positional information on a golf course having a plurality of regions, the device comprises:
a memory unit; and
a processing unit, wherein the processing unit is configured to
receive a first position on the golf course,
search for a first predetermined code representative of a first region on the golf course on a first image, and
determine a first minimum distance and a first maximum distance between the first position and the first region after having identified the first predetermined code.

14. The device of claim 13, wherein the processing unit is further configured to determine the first minimum distance and the first maximum distance within an angular range based on the first position.

15 The device of claim 14, wherein the angular range is further dependent on a line connecting the first position and a target position on the golf course.

16. The device of claim 13, wherein the first region is encoded with the first predetermined code prior to the processing unit searching for the first predetermined code.

17. The device of claim 14, wherein the processing unit is further configured to search for the first predetermined code along a first line connecting the first position and a boundary of the first image.

18. The device of claim 17, wherein the processing unit is further configured to:
search for a second predetermined code representative of a second region on the golf course along the first line; and
determine a second minimum distance and a second maximum distance between the first position and the second region after having identified the second predetermined code.

19. The device of claim 18, wherein the memory unit maintains a record of a sequence of identifying the first predetermined code and the second predetermined code, the first minimum distance and the first maximum distance, and the second minimum distance and the second maximum distance.

20. The device of claim 19, wherein the processing unit is further configured to analyze play on the golf course based on the record.

21. The device of claim 20, wherein the processing unit is further configured to analyze play by determining fairway in regulation (FIR), green in regulation (GIR), or positional information of a golf ball relative to the regions.

22. The device of claim 20, wherein the processing unit is further configured to update results from analyzing play each time the first position changes.

23. The device of claim 17, wherein the processing unit is further configured to search for the first predetermined code along a second line with a predetermined angular increment apart from the first line.

25. A device for determining positional information on a golf course having a plurality of regions, the device comprises:
a memory unit; and
a processing unit, wherein the processing unit is configured to
receive a first position on the golf course,
determine a golf hole on the golf course in which the first position belongs to based on coordinate information of a first image associated with the golf hole, and
determine the positional information after having identified the golf hole.

26. The device of claim 25, wherein the processing unit further configured to:
search for a first predetermined code representative of a first region in the golf hole on the first image; and
determine a first minimum distance and a first maximum distance between the first position and the first region after having identified the first predetermined code.
